(19) United States
(12) Patent Application Publication
(10) Pub. No.: US 2019/0217824 A1
(43) Pub. Date: Jul. 18, 2019

(54) Inflator and Combination Including the Same and an Air Tank

(71) Applicant: Louis Chuang, Taichung (TW)

(72) Inventor: Louis Chuang, Taichung (TW)

(21) Appl. No.: 16/182,672

(22) Filed: Nov. 7, 2018

(30) Foreign Application Priority Data
Jan. 12, 2018 (TW) 107101158

(51) Int. Cl. B60S 5/04

(52) U.S. Cl. CPC B60S 5/04

(57) ABSTRACT

An inflator includes a body having a first passage, a second passage, and a third passage. The first passage is configured to couple with an air tank or a compressed gas cartridge. The first passage unidirectionally intercommunicates with the second passage and the third passage. The second passage is configured to couple with an air pump. The third passage is configured to couple with a to-be-inflated-object. A first one-way valve unit is disposed between the first and second passages, such that compressed gas is only flowable from the second passage to the first passage. A second one-way valve unit is disposed between the first passage and the third passage, such that compressed gas is only selectively flowable from the first passage to the third passage.

### BACKGROUND OF THE INVENTION

The present invention relates to an inflator for inflating a bicycle tire and, more particularly, to an inflator for inflating an object, such as a bicycle tire. The present invention also relates to a combination including the inflator and an air tank.

When an ordinary air pump is used to inflate a tubeless bicycle tire, compressed air is apt to leak via a gap between a tire lip of the bicycle tire and a wheel rim, failing to achieve the inflation.

Conventionally, a user can only inflate the bicycle tire without an inner tire by an air compressor. Nevertheless, an air pump available in the market includes an extra air tank, and compressed gas is pre-stored in the extra air tank. During inflation, the compressed gas is released at a high pressure to inflate the tubeless bicycle tire.

A user already having a portable air pump must purchase an additional air pump with an air tank and has to carry a compressed gas cartridge, an inflator, and the portable air pump, which is extremely inconvenient.

### BRIEF SUMMARY OF THE INVENTION

An objective of the present invention is to provide an inflator for connecting with an air tank and an air pump, such that compressed gas can be produced and filled into the air tank and can be subsequently used to inflate a to-be-inflated-object. Alternatively, the inflator can be directly coupled to a compressed gas cartridge to inflate the to-be-inflated-object.

Another objective of the present invention is to provide a combination including an inflator and an air tank. The combination can be connected to an air pump to produce and fill compressed air into the air tank, and the compressed air in the air tank can be subsequently used to inflate a to-be-inflated-object.

In a first aspect, the present invention provides an inflator includes a body, a first one-way valve unit, and a second one-way valve unit. The body includes a first passage, a second passage, and a third passage. The first passage is configured to couple with one of an air tank and a compressed gas cartridge. The first passage unidirectionally intercommunicates with the second passage and the third passage. The second passage is configured to couple with an air pump. The third passage is configured to couple with a to-be-inflated-object. A first one-way valve unit is disposed between the first passage and the second passage, such that compressed gas is only flowable from the second passage to the first passage. A second one-way valve unit is disposed between the first passage and the third passage, such that compressed gas is only selectively flowable from the first passage to the third passage.

In a second aspect, the present invention provides a combination including an inflator and an air tank. The inflator includes a body, a first one-way valve unit, and a second one-way valve unit. The body includes a first passage, a second passage, and a third passage. The first passage unidirectionally intercommunicates with the second passage and the third passage. The second passage is configured to couple with an air pump. The third passage is configured to couple with a to-be-inflated-object. The first one-way valve unit is disposed between the first passage and the second passage. The second one-way valve unit is disposed between the first passage and the third passage. The air tank is detachably coupled to the first passage.

In an example, the body includes an outer threaded portion and an inner threaded portion. The outer threaded portion is disposed on an outer periphery of an end of the body. The outer threaded portion is configured to couple with an inner threading of a mouth of the air tank. The inner threaded portion is disposed on an inner periphery of the first passage. The inner threaded portion is configured to couple with an outer threading of a mouth of the compressed gas cartridge.

In an example, the second one-way valve unit is movable relative to the body between a first position and a second position. Compressed gas is prevented from flowing from the first passage to the third passage when the second one-way valve unit is in the first position. Compressed gas is flowable from the first passage to the third passage when the second one-way valve unit is in the second position.

In an example, the first one-way valve unit includes a first plug and a first elastic element. The first elastic element biases the first plug to permit the first plug to move relative to the first component.

In an example, the first one-way valve unit includes a first plug and a first elastic element. The first elastic element biases the first plug to permit the first plug to move relative to the first component.

In an example, the second one-way valve unit includes a sliding sleeve, a second plug, a second elastic element, and a third elastic element. The sliding sleeve is movably received in the second component and is switchable between the first position and the second position. The second plug is disposed between the second elastic element and the third elastic element. The second elastic element is disposed between the first component and the second plug. The third elastic element is disposed between the second plug and the sliding sleeve. Compressed gas is prevented from flowing from the first passage to the third passage when the sliding sleeve of the second one-way valve unit is in the first position. When the sliding sleeve of the second one-way valve unit is in the second position, the sliding sleeve is coupled with the to-be-inflated-object, the second elastic element and the third elastic element are compressed, and compressed gas is flowable from the first passage to the third passage.

In an example, a piercing unit is disposed in the first passage and has a piercing member and an anti-leak ring. The piercing member is configured to pierce a sealed opening of the compressed gas cartridge, permitting compressed gas in the compressed gas cartridge to flow into the first passage.

Thus, the combination including the inflator and the detachable air tank according to the present invention can be coupled to an air pump to produce compressed air to be stored in the air tank, and the air tank with compressed air or a compressed gas cartridge can be selectively used as an inflation source for inflating a to-be-inflated-object.

The present invention will become clearer in light of the following detailed description of illustrative embodiments of this invention described in connection with the drawings.

### DESCRIPTION OF THE DRAWINGS

FIG. 1 is a perspective view of a combination of an inflator and an air tank of an embodiment according to the present invention.

FIG. 2 is a partial, perspective view of the combination of FIG. 1.

FIG. 3 is a partial, cross sectional view of the combination of FIG. 1.

FIG. 4 is a partial, cross sectional view illustrating coupling of the combination of FIG. 1 with an air pump.

FIG. 5 is a partial, cross sectional view illustrating use of the combination of FIG. 1.

FIG. 6 is a cross sectional view illustrating use of an inflator together with a compressed gas cartridge.

### DETAILED DESCRIPTION OF THE INVENTION

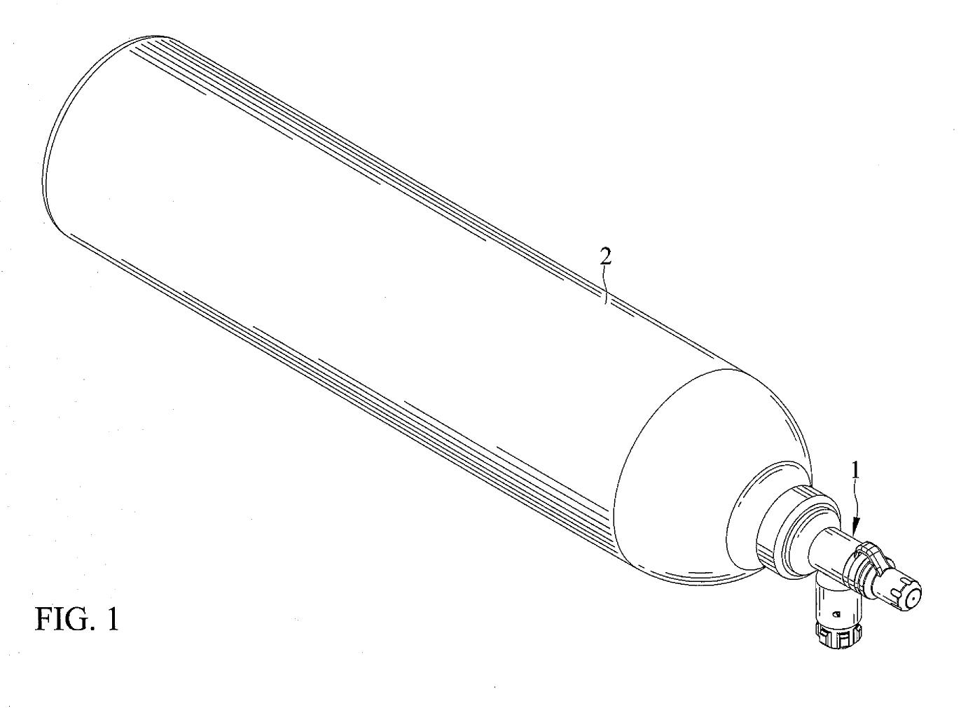

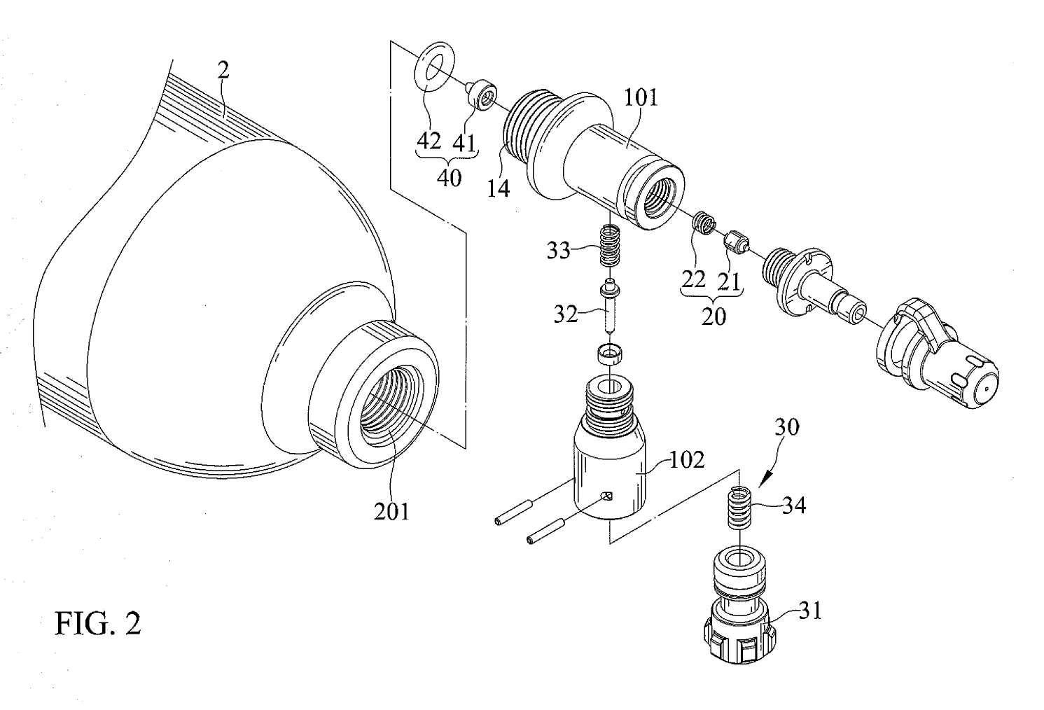

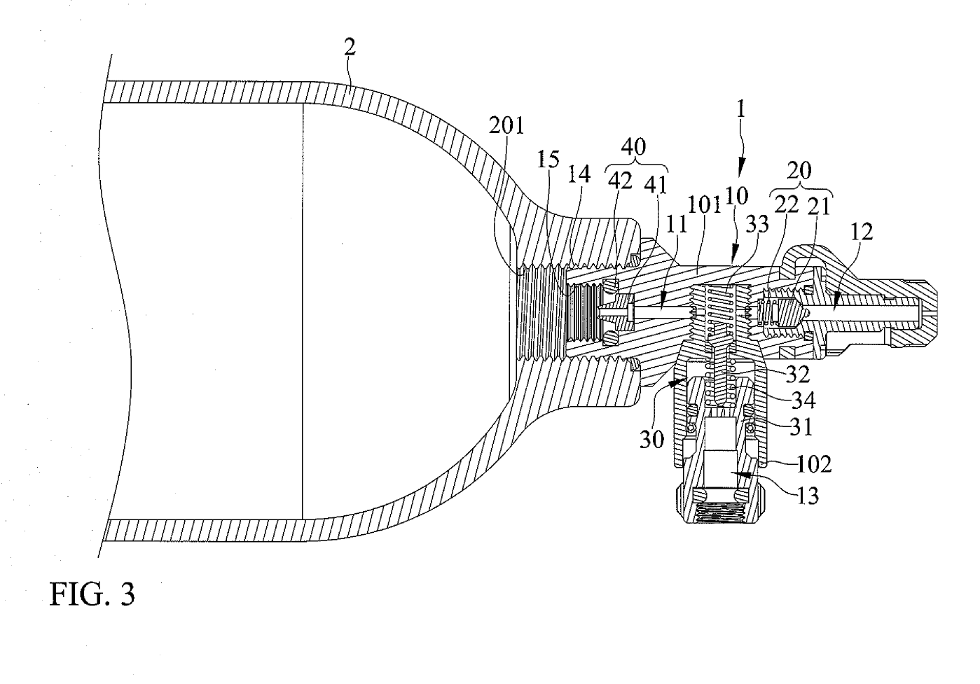

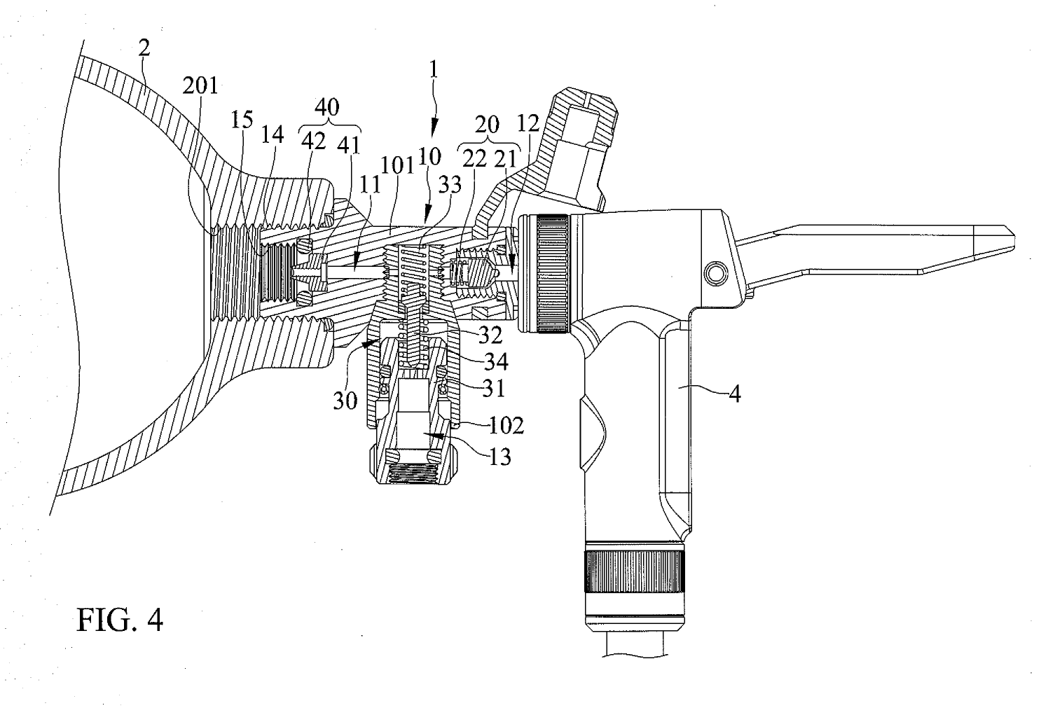

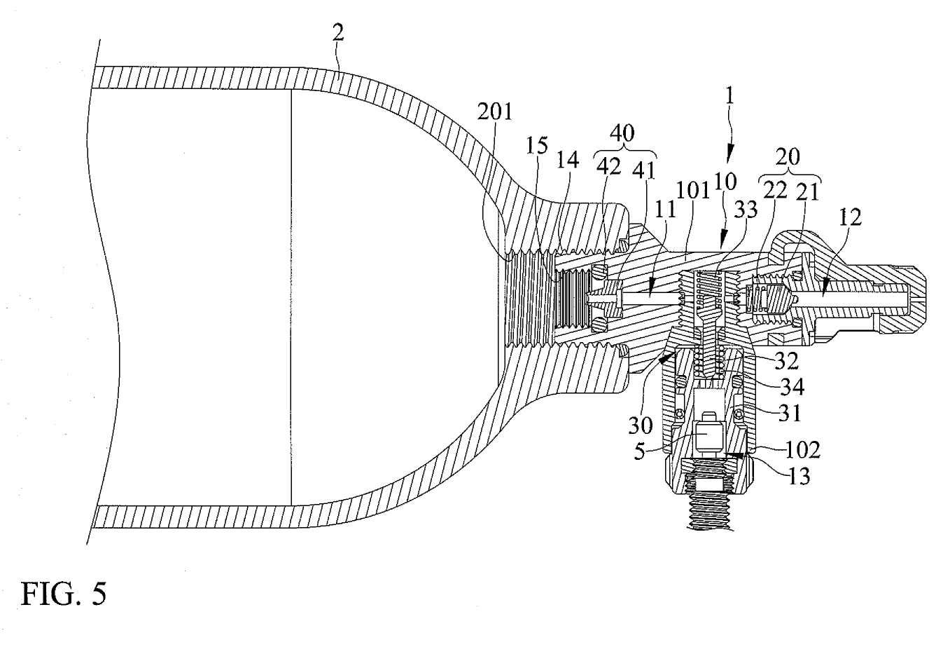

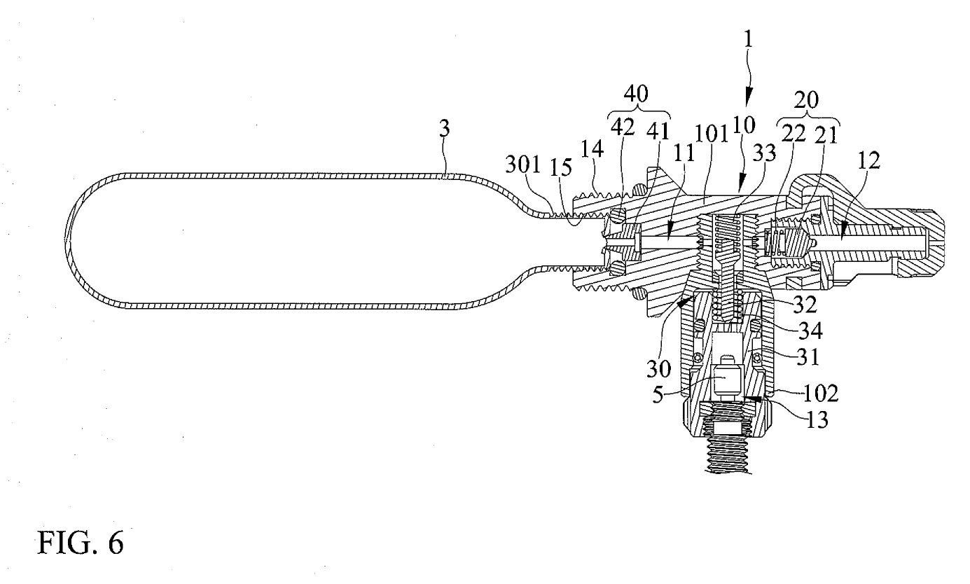

With reference to FIGS. 1-3, a combination of an embodiment according to the present invention includes an inflator 1 and an air tank 2 detachably coupled to the inflator 1. The combination of the inflator 1 and the air tank 2 can be coupled with an air pump 4 (FIG. 4). The air pump 4 can produce compressed gas (generally compressed air) that is filled into the air tank 2 via the inflator 1. Subsequently, the air tank 2 containing compressed gas can be used to inflate a to-be-inflated-object 5 (FIG. 5). Alternatively, the air tank 2 can be detached from the inflator 1. Then, a compressed gas cartridge 3 can be coupled to the inflator 1, and compressed gas in the compressed gas cartridge 3 can be used to inflate the to-be-inflated-object 5 (FIG. 6). The compressed gas cartridge 3 can be, but not limited to, a CO2 cartridge for bicycles. The air pump 4 can be any tool capable of producing compressed gas. The to-be-inflated-object 5 can be, but not limited to, a tubeless bicycle tire.

In this embodiment, the inflator 1 includes a body 10, a first one-way valve unit 20, a second one-way valve unit 30, and a piercing unit 40.

The body 10 includes a first passage 11, a second passage 12, a third passage 13, an outer threaded portion 14, and an inner threaded portion 15. The first passage 11 is configured to couple with one of an air tank 2 and a compressed gas cartridge 3. The first passage 11 unidirectionally intercommunicates with the second passage 12 and the third passage 13. The second passage 12 is configured to couple with an air pump 4. The third passage 13 is configured to couple with a to-be-inflated-object 5. The outer threaded portion 14 is disposed on an outer periphery of an end of the body 10. The outer threaded portion 14 is configured to couple with an inner threading 201 of a mouth of the air tank 2. Thus, the outer threaded portion 14 and the inner threading 201 have corresponding specifications to permit detachable threading coupling, such that the first passage 11 can be coupled with the air tank 2. The inner threaded portion 15 is disposed on an inner periphery of the first passage 11. The inner threaded portion 15 is configured to couple with an outer threading 301 of a mouth of the compressed gas cartridge 3. Thus, the inner threaded portion 15 and the outer threading 301 have corresponding specifications to permit detachable threading coupling, such that the first passage 11 can be coupled with the compressed gas cartridge 3.

In this embodiment, the body 10 includes a first component 101 and a second component 102 in threading connection with the first component 101. The first passage 11 and the second passage 12 are disposed in the first component 101. The third passage 13 is disposed in the second component 102. The second one-way valve unit 30 is movable relative to the second component 102 between a first position and a second position.

The first one-way valve unit 20 is disposed between the first passage 11 and the second passage 12, such that compressed gas from the air pump 4 is only flowable from the second passage 12 to the first passage 11 and is, thus, stored in the air tank 2. The first one-way valve unit 20 includes a first plug 21 and a first elastic element 22. The first elastic element 22 biases the first plug 21 to permit the first plug 21 to move relative to the first component 101, thereby selectively sealing a junction of the first passage 11 and the second passage 12. As a result, compressed gas from the air pump 4 can only flow from the second passage 12 to the first passage 11.

The second one-way valve unit 30 is disposed between the first passage 11 and the third passage 13, such that compressed gas from the air tank 2 or the compressed gas cartridge 3 is only selectively flowable from the first passage 11 to the third passage 13. The second one-way valve unit 30 includes a sliding sleeve 31, a second plug 32, a second elastic element 33, and a third elastic element 34. The sliding sleeve 31 is movably received in the second component 102 and is switchable between the first position and the second position. The second plug 32 is disposed between the second elastic element 33 and the third elastic element 34 and selectively seals the junction of the first passage 11 and the third passage 13, such that compressed gas from the air tank 2 or the compressed gas cartridge 3 is only selectively flowable from the first passage 11 to the third passage 13. The second elastic element 33 is disposed between the first component 101 and the second plug 32. The third elastic element 34 is disposed between the second plug 32 and the sliding sleeve 31. When the sliding sleeve 31 is in the first position, the second plug 32 seals the junction of the first passage 11 and the third passage 13, such that compressed gas from the air tank 2 or the compressed gas cartridge 3 cannot flow from the first passage 11 to the third passage 13. When the sliding sleeve 31 is in the second position, the sliding sleeve 31 is coupled with the to-be-inflated-object 5, such that the third passage 13 is coupled with the to-be-inflated-object 5. The second elastic element 33 and the third elastic element 34 are compressed. The second plug 32 does not seal the junction of the first passage 11 and the third passage 13, and compressed gas from the air tank 2 or the compressed gas cartridge 3 is flowable from the first passage 11 to the third passage 13 and into the to-be-inflated-object 5.

The first elastic element 22, the second elastic element 33, and the third elastic element 34 can be springs or other elements capable of biasing the first plug 21 and the second plug 32, which should not be limited in this embodiment.

The piercing unit 40 is disposed in the first passage 11 and has a piercing member 41 and an anti-leak ring 42. The piercing member 41 is configured to pierce a sealed opening of the compressed gas cartridge 3 when the compressed gas cartridge 3 is coupled with the first passage 11, permitting compressed gas in the compressed gas cartridge 3 to flow through the first passage 11, the second one-way valve unit 30, and the third passage 13 and into the to-be-inflated-object 5. The anti-leak ring 42 can be made of rubber material to prevent leakage of compressed gas.

With reference to FIG. 4, in use, the outer threaded portion 14 is coupled with the inner threading 201 of the mouth of the air tank 2 to intercommunicate the first passage 11 with the air tank 2. The second passage 12 is coupled with the air pump 4. The sliding sleeve 31 is in the first position, and the second plug 32 seals the junction of the first passage 11 and the third passage 13. The air pump 4 is operated to produce compressed gas that enters the second passage 12. Furthermore, compressed gas pushes the first plug 21 to compress the first elastic element 22 and, thus, enters the junction of the first passage 11 and the second passage 12. Then, compressed gas enters the air tank 2 via the first passage 11. Thus, an air tank 2 with compressed gas is provided. Furthermore, due to provision of the second one-way valve unit 30, compressed gas cannot flow from the first passage 11 to the third passage 13.

With reference to FIG. 5, in an inflating operation, the air pump 4 is detached from the second passage 12, and the sliding sleeve 31 is coupled with the to-be-inflated-object 5, such that the third passage 13 is coupled with the to-be-inflated-object 5. The sliding sleeve 31 is in the second position, the second and third elastic elements 33 and 34 are compressed, and the second plug 32 does not seal the junction of the first passage 11 and the third passage 13. Compressed gas from the air tank 2 flows through the first passage 11 and the third passage 13 and into the to-be-inflated-object 5.

With reference to FIG. 6, alternatively, the air tank 2 can be detached from the outer threaded portion 14, and the compressed gas cartridge 3 can be coupled with the inner threaded portion 15 by the outer threading 301, such that the first passage 11 is coupled with the compressed gas cartridge 3. Furthermore, the piercing member 41 pierces the sealed opening of the compressed gas cartridge 3. The sliding sleeve 31 is coupled with the to-be-inflated-object 5, such that the third passage 13 is coupled with the to-be-inflated-object 5. The sliding sleeve 31 is in the second position, the second and third elastic elements 33 and 34 are compressed, and the second plug 32 does not seal the junction of the first passage 11 and the third passage 13. Compressed gas from the compressed gas cartridge 3 flows through the first passage 11, the second one-way valve unit 30, and the third passage 13 and enters the to-be-inflated-object 5.

In view of the foregoing, in the combination of the inflator 1 and the air tank 2 according to the present invention, the inflator 1 can be coupled with the air tank 2 and the air pump 4 to produce compressed gas to be stored in the air tank 2 for subsequent inflation of the to-be-inflated-object 5, which is convenient for indoor cycling or prior to cycling. Alternatively, the inflator 1 can be independently coupled to the compressed gas cartridge 3 to inflate the to-be-inflated-object 5, which is convenient to use during cycling.

Specifically, the combination of the inflator 1 and the air tank 2 according to the present invention can cooperate with the air pump 4 to produce compressed gas to be stored in the air tank 2. Compressed gas in the air tank 2 or the compressed gas cartridge 3 can be selectively used as an inflation source for inflating the to-be-inflated-object 5.

Although specific embodiments have been illustrated and described, numerous modifications and variations are still possible without departing from the scope of the invention. The scope of the invention is limited by the accompanying claims.

1. An inflator comprising:
a body including a first passage, a second passage, and a third passage, wherein the first passage is configured to couple with one of an air tank and a compressed gas cartridge, wherein the first passage unidirectionally intercommunicates with the second passage and the third passage, wherein the second passage is configured to couple with an air pump, wherein the third passage is configured to couple with a to-be-inflated-object;
a first one-way valve unit disposed between the first passage and the second passage, such that compressed gas is only flowable from the second passage to the first passage; and
a second one-way valve unit disposed between the first passage and the third passage, such that compressed gas is only selectively flowable from the first passage to the third passage.

2. The inflator as claimed in claim 1, wherein the body includes an outer threaded portion and an inner threaded portion, wherein the outer threaded portion is disposed on an outer periphery of an end of the body, wherein the outer threaded portion is configured to couple with an inner threading of a mouth of the air tank, wherein the inner threaded portion is disposed on an inner periphery of the first passage, and wherein the inner threaded portion is configured to couple with an outer threading of a mouth of the compressed gas cartridge.

3. The inflator as claimed in claim 2, wherein the second one-way valve unit is movable relative to the body between a first position and a second position, wherein compressed gas is prevented from flowing from the first passage to the third passage when the second one-way valve unit is in the first position, and wherein compressed gas is flowable from the first passage to the third passage when the second one-way valve unit is in the second position.

4. The inflator as claimed in claim 3, wherein the body includes a first component and a second component in threading connection with the first component, wherein the first passage and the second passage are disposed in the first component, wherein the third passage is disposed in the second component, wherein the second one-way valve unit is movable relative to the second component of the body between the first position and the second position.

5. The inflator as claimed in claim 4, wherein the first one-way valve unit includes a first plug and a first elastic element, and wherein the first elastic element biases the first plug to permit the first plug to move relative to the first component.

6. The inflator as claimed in claim 4, wherein the second one-way valve unit includes a sliding sleeve, a second plug, a second elastic element, and a third elastic element, wherein the sliding sleeve is movably received in the second component and is switchable between the first position and the second position, wherein the second plug is disposed between the second elastic element and the third elastic element, wherein the second elastic element is disposed between the first component and the second plug, wherein the third elastic element is disposed between the second plug and the sliding sleeve, wherein compressed gas is prevented from flowing from the first passage to the third passage when the sliding sleeve of the second one-way valve unit is in the first position, and wherein when the sliding sleeve of the second one-way valve unit is in the second position, the sliding sleeve is coupled with the to-be-inflated-object, the second elastic element and the third elastic element are compressed, and compressed gas is flowable from the first passage to the third passage.

7. The inflator as claimed in claim 1, further comprising a piercing unit disposed in the first passage and having a piercing member and an anti-leak ring, wherein the piercing member is configured to pierce a sealed opening of the compressed gas cartridge, permitting compressed gas in the compressed gas cartridge to flow into the first passage.

8. A combination comprising:
an inflator including a body, a first one-way valve unit, and a second one-way valve unit, wherein the body includes a first passage, a second passage, and a third passage, wherein the first passage unidirectionally intercommunicates with the second passage and the third passage, wherein the second passage is configured to couple with an air pump, wherein the third passage is configured to couple with a to-be-inflated-object, wherein the first one-way valve unit is disposed between the first passage and the second passage, and wherein the second one-way valve unit is disposed between the first passage and the third passage; and
an air tank detachably coupled to the first passage.

9. The combination as claimed in claim 8, wherein the body includes an outer threaded portion disposed on an outer periphery of an end of the body, wherein the air tank includes an inner threading in a mouth of the air tank, and wherein the inner threading is configured to detachably couple with the outer threaded portion.

10. The combination as claimed in claim 9, wherein the second one-way valve unit is switchable relative to the body between a first position and a second position, wherein the compressed gas is prevented from flowing from the first passage to the third passage when the second one-way valve unit is in the first position, and wherein the compressed gas is flowable from the first passage to the third passage when the second one-way valve unit is in the second position.

11. The combination as claimed in claim 10, wherein the body includes a first component and a second component in threading connection with the first component, wherein the first passage and the second passage are disposed in the first component, wherein the third passage is disposed in the second component, wherein the second one-way valve unit is movable relative to the second component of the body between the first position and the second position.

12. The combination as claimed in claim 11, wherein the first one-way valve unit includes a first plug and a first elastic element, and wherein the first elastic element biases the first plug to permit the first plug to move relative to the first component.

13. The combination as claimed in claim 9, wherein the second one-way valve unit includes a sliding sleeve, a second plug, a second elastic element, and a third elastic element, wherein the sliding sleeve is movably received in the second component and is switchable between a first position and a second position, wherein the second plug is disposed between the second elastic element and the third elastic element, wherein the second elastic element is disposed between the first component and the second plug, wherein the third elastic element is disposed between the second plug and the sliding sleeve, wherein the compressed gas is prevented from flowing from the first passage to the third passage when the sliding sleeve of the second one-way valve unit is in the first position, and wherein when the sliding sleeve of the second one-way valve unit is in the second position, the sliding sleeve is coupled with the to-be-inflated-object, the second elastic element and the third elastic element are compressed, and compressed gas is flowable from the first passage to the third passage.
